(19) United States
(12) Patent Application Publication
(10) Pub. No.: US 2008/0035003 A1
(43) Pub. Date: Feb. 14, 2008

(54) Process for Producing Printed Articles

(76) Inventor: Ivan Brignani, Limbiate (IT)

Correspondence Address: HESS PATENT LAW FIRM, P.C., 9 MIRAMAR LANE, STAMFORD, CT, 06902, US

(21) Appl. No.: 11/861,445

(22) Filed: Sep. 26, 2007

(30) Foreign Application Priority Data
Aug. 1, 2007 (EP) 07015085.9
Aug. 4, 2006 (IT) M2006A001580

(51) Int. Cl. B41F 33/00

(52) U.S. Cl. 101/483

(57) ABSTRACT

A process for the production of printed articles which include at least one support on which one or more characters are printed, and at least one layer of coating, removable by abrasion, capable of hiding the printed characters underneath. The process provides the use of transparent ink to print the characters, covering them with colored ink and applying a coat of transparent varnish over the layer of colored ink.

### BACKGROUND OF THE INVENTION

1. Field of the Invention

The present invention concerns a process for the production of printed articles and, in particular, printed articles with one or more surface portions on which characters are printed, such as words, letters, logos, numbers, codes or the like, on which a layer of an upper coating is applied, removable by abrasion, with the ability to hide the characters underneath.

2. Description of Related Art

Printed articles with these characteristics are extensively used, for example in the form of tickets for instant lotteries, so-called “Scratch and Match” lotteries, or cards for parking in urban areas, so-called “Scratch and Park” cards. These articles are generally printed on very heavy paper as they must be sufficiently sturdy to withstand the mechanical action of abrasion applied to uncover the hidden characters, but must also prevent seeing the hidden characters through it in case of articles for instant lotteries.

Other articles of this kind, such as telephone cards and similar items, are printed on supports in plastic having, in any case, adequate thickness.

All the articles of the known type are produced with essentially similar printing processes, whereby the hidden characters are printed in dark ink on a light background. This is then coated with a layer of transparent varnish to protect the characters underneath from the abrasive action and prevent anchorage of the top coat of matt paint which is applied over the coat of transparent varnish. The matt paint provides the covering layer that hides the characters underneath and that can be removed by abrasion using a sufficiently rigid object such as a coin or fingernail.

A process of the known type such as that described above does not lend itself to application with supports of limited thickness, such as sheets of ordinary paper or coated paper of the type used, for example, to print labels or the like, or thin plastic film such as that used for packaging or wrapping.

Indeed, a thin support would be transparent enough to permit reading the hidden characters through the coating layer of matt paint.

### SUMMARY OF THE INVENTION

One aspect of the present invention concerns a process that allows to print articles with characters hidden by a coating removable by abrasion on particularly lightweight or thin supports.

Another aspect of the present invention concerns a process of the type described above, and the articles thus produced, that will make it impossible to see through the support and read the hidden characters underneath a coating layer, regardless of the opacity of the support and/or its thickness.

These aspects are achieved according to the invention with a process for printing articles including at least one support on which one or more characters are printed and at least one layer of an upper coating, removable by abrasion, capable of hiding the printed characters underneath it, the process including the steps of:
a) printing on the support one layer of a first ink in accordance with the configuration of the one or more characters, wherein the first ink is a transparent ink;
b) printing a layer of at least one second colored ink over the characters; and
c) printing at least one layer of transparent varnish over the layer of the second ink.

The hidden characters, having been printed with transparent ink, are absolutely invisible through the support and therefore it is even possible to use supports having very thin thickness.

### BRIEF DESCRIPTION OF THE DRAWING

Other advantageous characteristics of the present invention will be made more evident by the following description, made by way of example with reference to the schematic drawings enclosed in which:

FIGS. 1 and 2 are cross-section views of some steps of the process in accordance with the present invention;

FIG. 3A is a cross-section view of a printed article obtained as the end product of the process in accordance with the present invention;

FIG. 3B is a cross-section view of another possible embodiment of the printed article obtained as the end product of the process in accordance with the present invention;

FIG. 4A is a cross-section view of the printed article shown in FIG. 3A after abrasion of the covering layer; and

FIG. 4B is a cross-section view of the printed article shown in FIG. 3B after abrasion of the covering layer.

### DETAILED DESCRIPTION OF THE PREFERRED EMBODIMENT

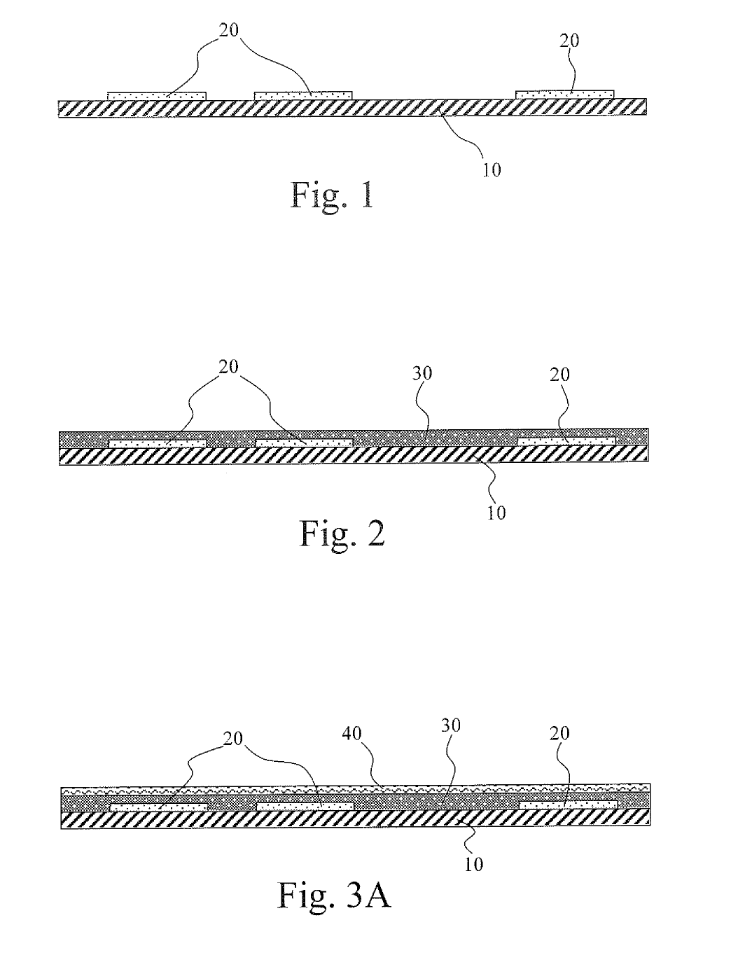

Referring to the view in FIG. 1, a printed article according to the present invention is obtained basically by printing a layer of a first ink in accordance with the configuration of one or more characters 20 on a support 10. The ink with which the characters 20 are printed is a transparent silicone-based ink.

The support 10 is a sheet of paper or plastic materials of limited thickness, consisting for example of a coated or matt sheet of paper or cardboard, or a film of polyolefin or plastic material, such as polypropylene, polyethylene, PVC and similar materials for packaging or wrapping. These and other types of supports, such as plain paper without coating, can be made suitable for the process in accordance with the invention by prior application of a layer of suitable products, such as a primer or the like.

At least one second coating of a UV-dried colored ink 30 is applied on the characters 20 (FIG. 2). This layer of ink 30 is applied uniformly at least to the entire area containing the characters so as to fill the spaces between the characters 20 and cover them. The colored ink 30 must be of the type that can be anchored to the support 10 but not to the layer underlying the first ink with which the characters 20 are printed. Alternatively, different inks of two or more different colors can be used, provided that they all have the same characteristics of compatibility with the support 10 and with the transparent ink of the characters 20 as regards anchoring.

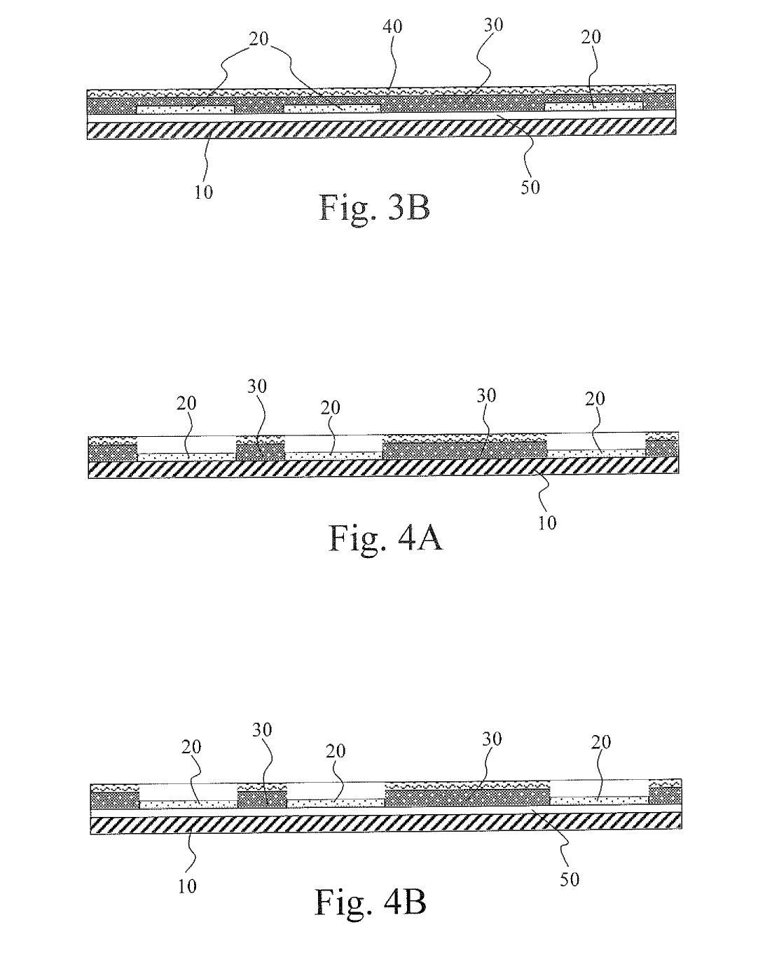

The end product, shown in FIG. 3A, is obtained by printing a layer of transparent varnish 40 over the layer of the second ink 30.

The layer of transparent varnish 40 must be printed according to a particular security graphic technique to eliminate the uniformity of the surface and make it non-reflecting. This process serves to eliminate any reflections that could make the hidden characters visible with grazing light.

The structure of the texture with which the varnish 40 is applied is chosen on the basis of the characters to hide. For example, the same configuration as the characters to be hidden can be repeated and overlaid with a different screen ruling.

FIG. 3B illustrates another possible embodiment of a printed article according to the invention. First the support 10 is coated with a layer of a product 50 capable of giving particular properties to the surface to be printed. The product 50 can be, for example, a primer to prepare the surface of the support 10 to receive the inks of the layers 20 and/or 30. Alternatively, or also in combination, the product 50 can be, for example, a colored ink, preferably of the UV-dried type, to form a base of a desired color for the characters printed in transparency.

FIGS. 4A and 4B show the articles of FIGS. 3A and 3B, respectively, after removal of the top covering. After abrasion, the transparent varnish 40 and the layers of ink 30 are removed only from the underlying characters 20, because the ink 30 is not anchored to the ink of the characters 20 but only to the support 10. Consequently, the characters 20 are visible, bordered by the areas 30 with respect to the background consisting of the surface of the support 10 (FIG. 4A) or by a possible colored background 50 (FIG. 4B) applied first to the support 10.

In addition to the advantages already mentioned previously, it is important to stress that the process according to the invention lends itself to different printing techniques such as offset, dry offset, flexographic, rotogravure, silkscreen, inkjet and the like.

The following examples illustrate some practical executions of the process according to the invention that give as a result printed articles having the desired characteristics.

### EXAMPLE 1

Matt coated paper weighing 90 g., produced by the Burgo paper mill, was used as printing support 10.

The characters 20 were printed using the “dry offset” method with a transparent ink called Deltacote 12800 produced by the Colorgraf company, with the addition of the article “Release 202067” in a proportion of 30% to 70% by volume.

The characters 20 were then overprinted with a second, colored ink 30 of the UV-dried type called XPRESS and produced by the Colorgraf company. The ink layer 30 was applied using the lithographic offset method.

Overprinting with the transparent varnish 40 using appropriate graphics was done with a closed-chamber flexographic printing system. The security texture was chosen so as to reproduce the hidden characters repeated and overlaid with a screen ruling of 30%, 60% and 80%.

From the observation of the articles thus obtained it was not possible to distinguish the hidden characters through the paint. Removal of the upper coat by abrasion did not cause any damage to the support in the printed zones.

### EXAMPLE 2

The same process as Example 1 was performed on supports consisting of glossy coated paper weighing 90 g. produced by the Marchi Group paper mill. Also the printed articles obtained using this type of support have the same characteristics as those obtained in Example 1.

### EXAMPLE 3

Ordinary paper weighing 80 g. was used after treating the surface to be printed first with a “primer” called Release Dry Offset produced by Colorgraf.

The process described in Example 1 was then used to obtain printed articles with characteristics similar to those of Examples 1 and 2.

What is claimed is:

1. A process for the production of printed articles including at least one support on which one or more characters are printed, and at least one layer of an upper coating, removable by abrasion, capable of hiding the printed characters underneath, the process including the steps of:
a) printing on said support a layer of a first ink according to the configuration of said one or more characters;
b) printing a layer of at least one second colored ink over said one or more characters;
c) printing at least one layer of transparent varnish over the layer of said second ink,
characterized in that said first ink is a transparent ink.

2. The process according to claim 1, wherein said first ink is a silicone-based transparent ink.

3. The process according to claim 1, wherein said at least one second colored ink is a type anchorable to said support but not anchorable to the underlying layer of said first ink.

4. The process according to claim 1, wherein said at least one second colored ink is a UV-dried type of ink.

5. The process according to claim 1, wherein said layer of transparent varnish is printed in said step c) in accordance with a pre-established texture.

6. The process according to claim 1, wherein said layer of transparent varnish is printed in said step c) with the same configuration as said one or more characters printed in said step a).

7. The process according to claim 1, wherein at least one layer of a colored ink is applied on said support as a background prior to performing said step a) of printing said one or more characters with said first ink.

8. The process according to claim 7, wherein said colored background ink is a UV-dried type of ink.

9. The process according to claim 1, wherein said support is a glossy art or matt art paper.

10. The process according to claim 1, wherein said support is an uncoated paper and wherein at least one layer of primer is applied on said support before performing said step a) of printing said one or more characters with said first ink.

11. The process according to claim 1, wherein said support is a film made of plastic material.

12. A printed article including at least one surface portion produced with the process according to any of claims 1 to 11.
